(19) United States
(12) Patent Application Publication
(10) Pub. No.: US 2016/0335787 A1
(43) Pub. Date: Nov. 17, 2016

(54) SEGMENTED STATUS DISPLAY

(71) Applicant: Hewlett Packard Enterprise Development LP, Houston, TX (US)

(72) Inventors: Andrea Lynn Martin, Roseville, CA (US); Kadence Bret Airsworth, Fort Collins, CO (US); Mark Edouard Mayotte, Fort Collins, CO (US)

(73) Assignee: Hewlett Packard Enterprise Development LP, Houston, TX (US)

(21) Appl. No.: 15/109,519

(22) PCT Filed: Jan. 9, 2014
(86) PCT No.: PCT/US14/10914

§ 371 Date: Jul. 1, 2016

(51) Int. Cl. G06T 11/20; H04L 12/24; G06F 3/0482; G06T 11/00; G06F 3/0484

(52) U.S. Cl. CPC G06T 11/206; G06T 11/203; G06T 11/001; G06F 3/04847; G06F 3/04845; G06F 3/0482; H04L 41/22; G06F 2203/04805; G06T 2200/24

(57) ABSTRACT

Displaying a status of entities in a segmented graph on a display are provided. An example includes representing a computing network as a geometric shape, wherein each of a number of segments of the geometric shape represent individual entities. A first region in the geometric shape is displayed to indicate the type of networked units represented by each of the segments. A second region that represents a first status level for an event for an entity is displayed. A color of a segment is changed, or a length of the segment is extended into the second region, or both, to indicate the first status level for the event.

### BACKGROUND

Displaying the status of a large group of interconnected computing entities, such as in a server farm or corporate network can be difficult. Often a heat map or a tree map is used to display the status of a large number of entities. A heat map typically breaks an area into a number of shapes and colors them by status. A tree map does the same thing by breaking up the available space into rectangles, but also allows sections of the map to be grouped together with a border around the group and typically a textual header above it. However, these solutions can be challenging to use when there are too many entities to identify each one on the display, as the user must scan both horizontally and vertically to cover the entire area of the map.

### BRIEF DESCRIPTION OF THE DRAWINGS

Certain examples are described in the following detailed description and in reference to the drawings, in which:

FIG. 1 is a computer network that can display a status of a number of entities in a segmented display on a single screen;

FIG. 2 is a segmented display that can be used to display a status of a number of entities;

FIG. 3 is a segmented display showing a magnification tool that can be used to display information on a number of entities simultaneously;

FIG. 4 is another example of a segmented display in which each unit having an alert message is identified;

FIG. 5 is another example of a segmented display, in which all entities are identified on the display;

FIG. 6 is another example of a segmented display, showing a status display for a large number of entities simultaneously in a stadium configuration;

FIG. 7 is a process flow diagram of a method for displaying a status of a number of entities using a segmented display; and

FIG. 8 is a block diagram of a computer readable medium that includes modules for displaying a status of number of entities simultaneously.

### DETAILED DESCRIPTION

Examples described herein provide methods and systems for the concise visualization of the status and grouping of a large number of entities, while also allowing specific entities to be selected for the display of further information. Entities that may be displayed include storage units, server units, network interface units, power units, user systems, or any combinations. For example, the technique may be useful in the management of data centers by providing a fast technique for accessing information about particular units within the data centers. In other examples, the techniques may be useful for managing large corporate networks, including, for example, data storage, individual users, network loading, database conditions, and the like.

Each entity can be displayed as a segment of a shape, for example, as a portion of a circle or an arc. The identities of the groups the entity belongs to can be shown in a separate region, such as along an outer rim of an arc or in an inner area. The status of each individual entity can be represented by a color as well as a length of the segment.

The techniques described provide a user a concise view of the status of a large infrastructure in a relatively small amount of physical space. It also provides an easy way for a user to see which entities need attention. Further, the segmented graph allows the user to quickly access data for a specific entity. It also allows the user to focus on entities of a certain type or types, and entities having a specific status or statuses.

Examples are not limited to arcs, but can also include circles, rectangles, and the like. Combinations of shapes can be used, such as a combination of a flat plane with an arc on one or either end, producing a segmented graph in the shape of a stadium.

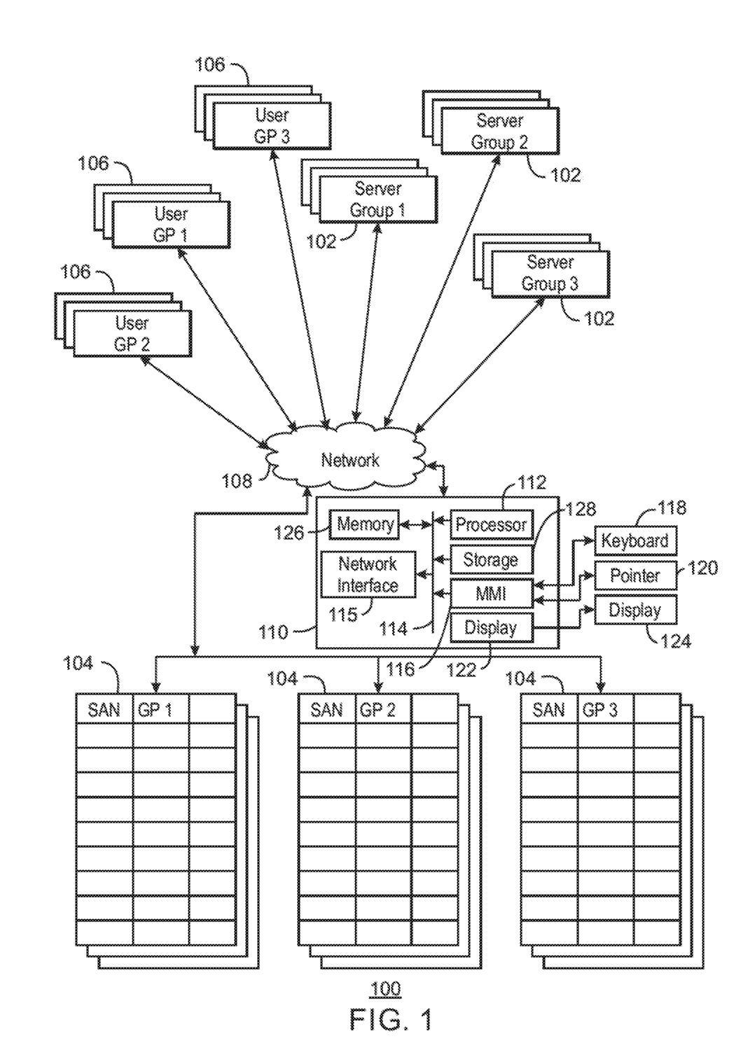

FIG. 1 is a computing network 100 that can display a status of a number of entities in a segmented display on a single screen. The entities may include, for example, servers 102, storage systems 104, user systems 106, and many others. Segmented graphs, as discussed herein, can be used to provide operational status for any number of these entities, and for subunits within each unit, such as power supplies, disk drives, caches, and the like.

All of these entities may be in communication over a network 108. The network 108 may include public networks, private networks, virtual private networks (VPNs), or any combinations. Further, the network can include a wide area network (WAN), a local area network (LAN), a wireless wide area network (WWAN), the Internet, or any combinations thereof.

In one example, the computing network 100 can include a management system system 110 that can track and display the status of entities in the computing network 100. The management system 110 may include a processor 112 that is adapted to execute stored instructions. The processor 112 can be a single core processor, a multi-core processor, a computing cluster, or any number of other appropriate configurations. The processor 112 can be connected to any number of devices over a system bus 114, e.g., AMBA®, PCI®, PCI Express®, Hyper Transport®, Serial ATA, among others. For example, the processor 112 may be in communication with the network 108 through a network interface 115 coupled to the processor 112 through the system bus 114.

The processor 112 may be connected through the system bus 114 to an input/output (I/O) device interface or human-machine interface (HMI) 116 adapted to connect the management system 110 to one or more I/O devices. The I/O devices may include, for example, a keyboard 118 and a pointing device 120, wherein the pointing device may include a touchpad or a touchscreen, among others. The I/O devices may be built-in components of the management system 110, or may be devices that are externally connected to the management system 110.

The processor 112 may also be linked through the system bus 114 to a display device interface 122 adapted to connect the management system 110 to display devices 124. The display devices 124 may include a display screen that is a built-in component of the management system 110. The display devices 124 may also include computer monitors, televisions, or projectors, among others, that are externally connected to the management system 124.

The processor 112 may also be linked through the system bus 114 to a memory device 126. In some examples, the memory device 126 can include random access memory (e.g., SRAM, DRAM, eDRAM, EDO RAM, DDR RAM, RRAM®, PRAM, among others), read only memory (e.g., Mask ROM, EPROM, EEPROM, among others), non-volatile memory (PCM, STT MRAM, ReRAM, Memristor), or any other suitable memory systems.

The processor 112 may also be linked through the system bus 114 to a storage device 128. The storage device 128 may contain data and program files that include a list of entities, the locations of the entities on the network 108, and the links to obtain the operation status of the entities. After the operational status of the entities on the network 108 is obtained, it can be displayed on a segmented graph as described herein.

The computing network 100 is not limited to the entities shown but may have any number of other types of entities in addition. For example, the computing network may also include such devices as storage attached networks (SANs), network attached storage (NAS), routers, switches, network interfaces, mobile phones, laptop computers, desktop computers, and tablet computers, among others. Further, not all of the devices shown in FIG. 1 need be present.

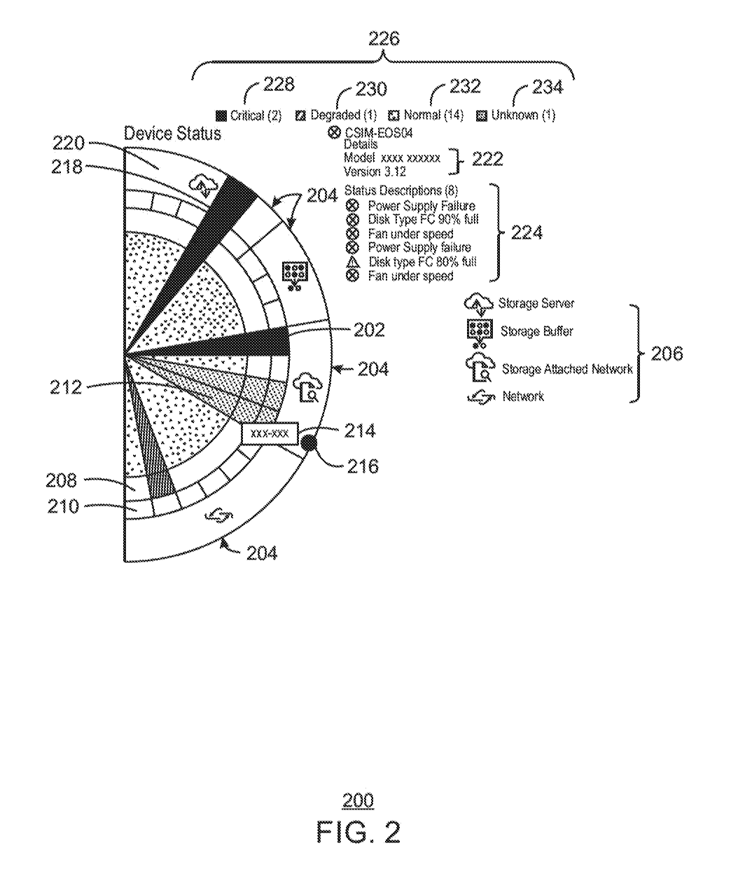

FIG. 2 is a segmented display that can be used to display a status of a number of entities as a segmented graph in the shape of an arc 200. Each of the entities is shown as a single segment of the arc 200, such as the entity represented by segment 202. A group segment 204 of the arc 200 can be used to indicate the type 206 of entity.

The status of the entity associated with each segment can be represented by the color or the length of the segment. For example, the segment associated with an entity that is being called to the attention of a user can be turned to yellow or red and made longer in length. Different outer bands can indicate a degraded status 208 (e.g., a bandwidth issue caused by a failed port) or a critical status 210 (e.g., a power supply thermal alarm indicating imminent failure of the power supply). For example, the entity represented by segment 202 is indicated in red, with a length extending into the critical status band 210 to indicate an urgent issue. Additional bands can be present if there are more status levels.

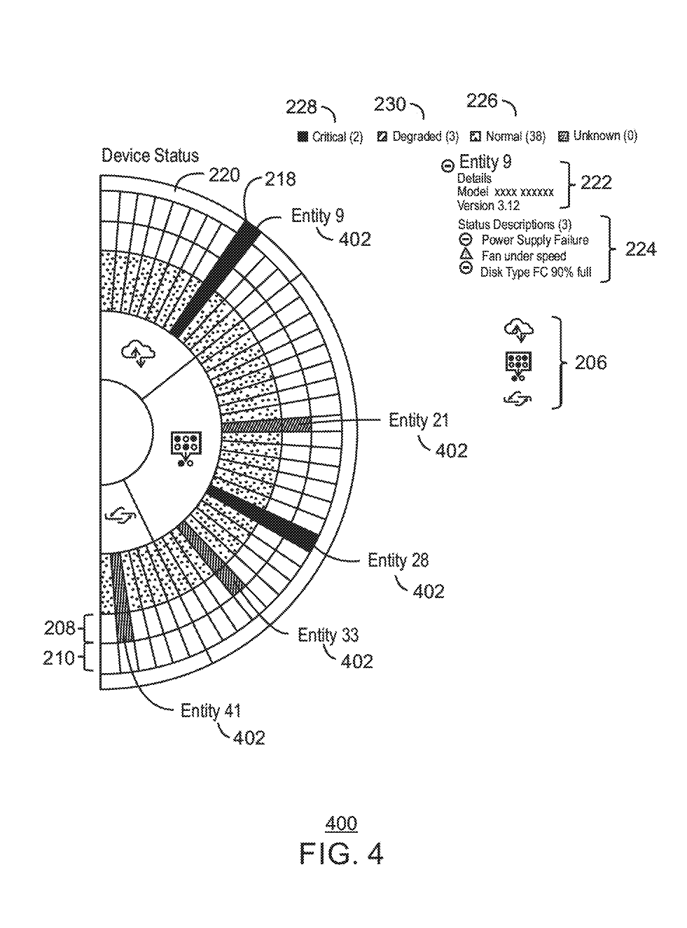

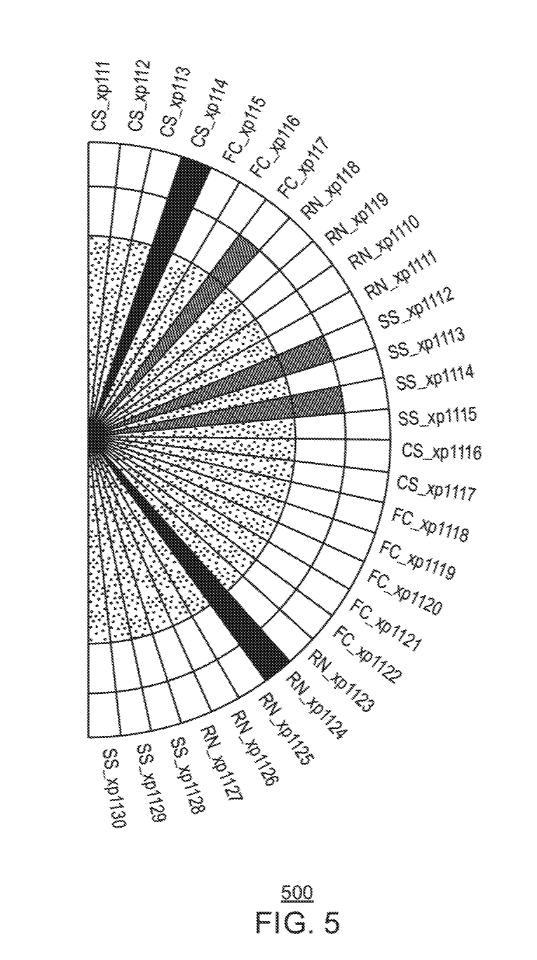

When the user positions a screen cursor (e.g., mouse pointer) over any segment, the segment can be highlighted by changing the intensity of the color, for example, as shown for a highlighted segment 212. The identity of the highlighted segment 212 can be shown in an identification box 214 when the cursor is over the highlighted segment 212. Alternatively, the identification can be shown as a label on the outside rim of the graph. If other segments are labeled in the graph as in FIG. 4 or FIG. 5, the label of the highlighted segment would have a different color or weight to make it stand out from the others.

Any number of techniques for indicating the identities of the entities associate with particular segments can be used. Depending on the number of entities and the amount of available space to show the arc, labels to display the identity of the entity can be added. If large numbers of entities are present, showing this data on demand may be performed instead, for example, by showing the identification box 214 when a screen pointer pauses (hovers over) a segment, or by showing text to identify segments when the number of entities displayed drops below a certain number, among others. An indicator 216 can be located along the group segment 204 to draw further attention to the highlighted segment 212.

Segments can be selected by clicking on them, for example, as shown for a selected entity segment 218. The selection can remain in place until the user changes the selection, regardless of any segments that are currently highlighted by mouse overs. This can provide a user an easy way to traverse through the entities and find what he is looking for, before making a selection.

When an entity is selected for further details, the selected entity segment 218 can protrude out further than the other entities to indicate that it is selected, and allow for navigation to something that would provide more information. For example, the selected entity segment 218 can be animated to dynamically extend in length to the outer rim of the arc, making it stand out from other segments. The group segment 204 for the selected entity segment 218 can be darkened or highlighted in some way to indicate the selected group 220. Additional details about the selected entity can be shown in an area outside of the arc 200. The details can include to identification details 222 and a number of status descriptions 224 for the selected entity segment 218. Navigation to further details can be provided by activating the selected entity segment 218 (e.g. by a double click), by activating the unit name, or by providing a button or link near or within the selected entity segment 218.

A legend 226 can be included with the display of the arc 200 to identify the status colors. For example, the legend 226 can include items showing the color and number of entities with a status of critical 228, degraded 230, normal 232, unknown 234, and any other status level that can be represented by the entities in the display.

A user can filter the segmented graph by clicking on an item in the legend to toggle on or off the display of the segments relating to that item. For example, if a user wants to focus only on items needing attention, the normal 232 item may be selected to toggle off the display of segments in that category. To restore the display, the user would click on the normal 232 item and those segments would be restored to the segmented graph. Similar filtering mechanisms can allow the user to toggle entire groups of segments on or off, for example, by clicking on a particular type 206 indicator to exclude or include an individual group.

The segmented graph can be scaled to allow for the display of large numbers of items. For example, the arc 200 can be configured to be rotated, allowing the entities to move in and out of the viewable area. This can be implemented by allowing the user to swipe or drag along the arc 200 or by providing buttons that allow the user to rotate the arc by a single entity at a time, by a whole page, or by a full arc at a time. In this example, if all current entities are viewable at one time, they would simply rotate radially through the arc, never leaving the viewable area.

The segmented graph is not limited to the example shown in FIG. 2, but could include any number of similar implementations. For example, instead of an arc 200 the geometric shape could be rectangular, circular, or other shapes. Further, in this implementation the group segment 204 of the arc 200 identifies the entities with an icon, but a text label could be used as well. The group segments 204 could also be shown as segments in the center of the arc as well, making the entities appear as a band along the outer rim of the arc 200.

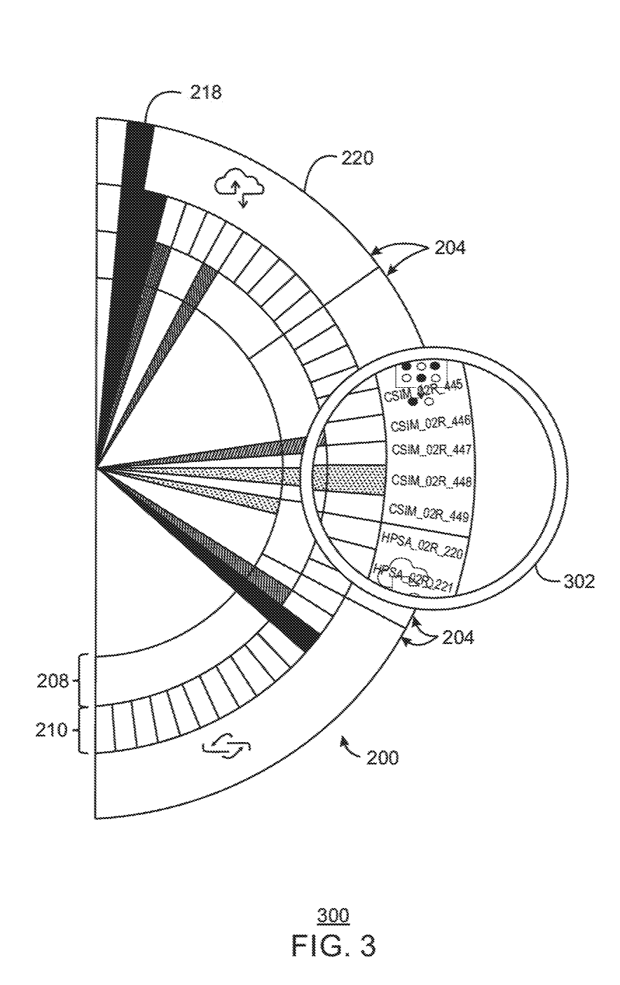

Any number of other segmented graphs can be implemented to allow for display of selected items. A few examples of these segmented graphs are discussed with respect to FIGS. 3-6. Although these examples are illustrating variations on arcs, it can be understood that any number of other geometric shapes can be used for the segmented graph.

FIG. 3 is a segmented display 300 showing a magnification tool 302 that can be used to display information on a number of entities simultaneously. Like numbered items are as discussed with respect to FIG. 2. In small spaces, or with a very large amount of entities, identifying data can be shown on demand instead. For example, a tool could be selected to show the identities of a range of entities in close proximity in a window that has a magnifying glass effect. The magnification tool 302 may be automatically activated when the user hovers over any area or it may be selected as a control by the user. The magnification tool 302 can be displayed as a moving window, allowing the user to examine any group of items. In other examples, the magnification tool 302 may have a fixed position, allowing the user to rotate the arc 200 to move entities into a magnifying glass window that is anchored in the center of the arc 200. Alternatively, the same concept can be implemented without the magnifying glass by showing the identity of the entities that are adjacent to the highlighted segment.

FIG. 4 is another example of a segmented display in which each entity having an alert message is identified. Like numbered items are as discussed with respect to FIG. 2. In one example, the entities having status alerts at or above a certain level may be identified by labels 402. The level at which the labels 402 appear, such as critical 228 or degraded 230, may be selected by the user.

FIG. 5 is another example of a segmented display 500, in which all entities are identified on the display. If the number of entities is small, or if filtering is selected that restricts the number of entities below a certain number, such as 20, 30, or 40, among others, all of the entities may be labeled. For example, labels to display the identity of the entity can be added radially along the outer rim of the arc or added horizontally with lines connecting the labels to each segment.

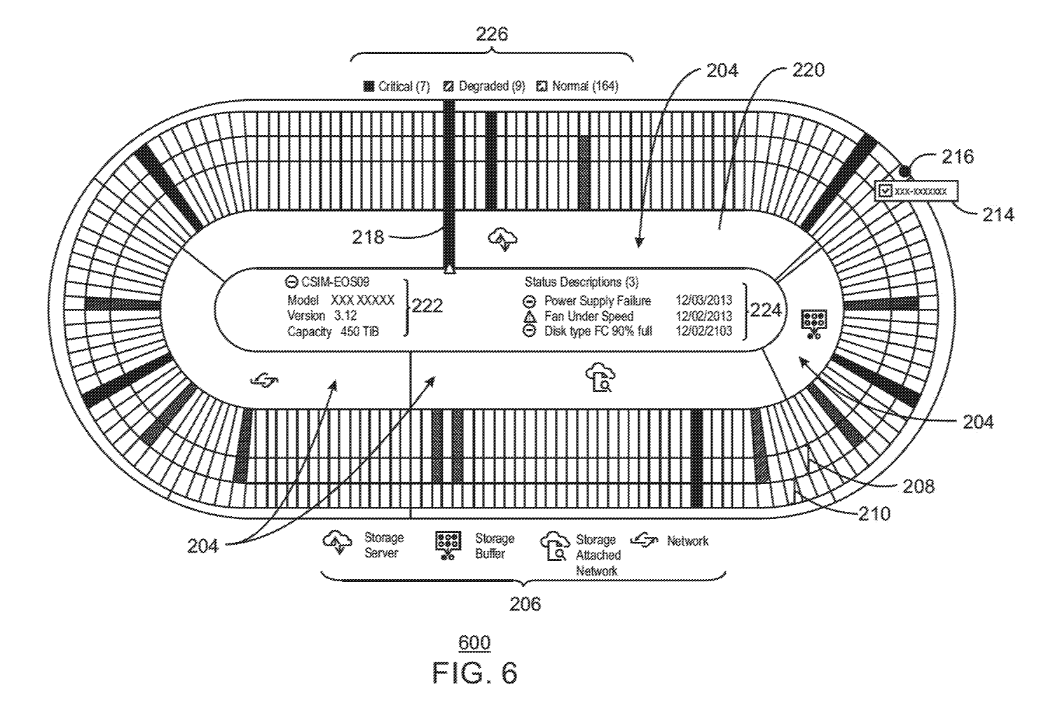

FIG. 6 is another example of a segmented display 600, showing the status of a large number of entities simultaneously. Like numbered items are as described with respect to FIG. 2. In this example, two arcs are positioned at either end of a large rectangular shape, presenting the segments in a stadium configuration. This allows for many more segments to be displayed for entities in a system. When particular filters are selected, for example, by toggling the display of items in the type 206 or legend 226, the display may be changed by increasing the size of the individual segments. Alternatively, a new display may be shown using a different geometric configuration, such as an arc or circle, among others.

The segmented display 600 in FIG. 6 also illustrates a number of other variations that may be used. In this example, the status descriptions 224 show a date for the occurrence of an event for the entity represented by the selected segment 218. Further, the group segments 204 showing the types of the entities are located in the center of the graph, allowing the segments to have more room at the outer edge.

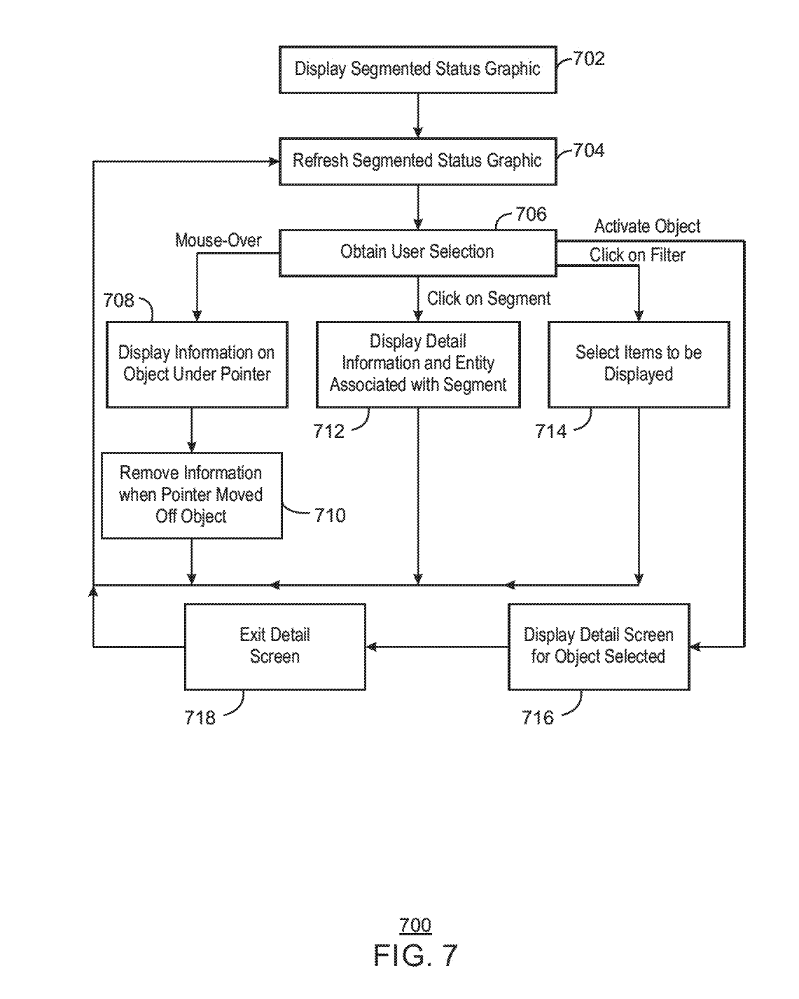

FIG. 7 is a process flow diagram of a method 700 for displaying a status of a number of entities using a segmented display. The method 700 begins at block 702 with the initial display of a segmented status graph, for example, when a status program is first accessed. At block 704, the segmented status graph may be refreshed, for example, after leaving a detailed screen or selecting filters, among other actions.

At block 706, user input is obtained. The user input can include any number of different actions, as described herein, such as passing a screen pointer over a segment (mouse-over) stopping a pointer on a segment (hover), clicking on a segment, activating an object represented by a segment, or clicking on a filter selection, among others.

If the user input is a mouse-over or hover-over a segment, at block 708 information on the segment may be displayed, for example, as described with respect to FIG. 2. The information may include the identity of the entity under the pointer, a color change of the segment under the pointer, or other information relevant to determining the status of the object. Further, an indicator may be used to clearly mark the segment that is highlighted, such as an arrow or dot at the outside edge of the segmented graph.

When the pointer is moved from the highlighted segment, at block 710, the highlighted information is removed from the screen. Process flow resumes at block 704 and the segmented status graph is refreshed.

If the user input is the selection of a segment, for example, by clicking on the segment, at block 712, information about the segment and the entity associated with the segment can be displayed in another region of the screen. The information can include the status, the name of the entity, the type of entity, events that are currently involving that entity, dates and time for the events, and the like. The segment color can be changed, such as by increasing the intensity, to indicate that it is being displayed. Further, the region indicating the type of entity selected can also be changed to indicate the group in which the segment resides, e.g., disks, networks, power supplies, and the like. Process flow then resumes at block 704 to redraw the graph with the new parameters. If a user selects another location, the information for the first segment is removed the segment color is restored, in addition to any changes made to a newly selected segment.

If the user input is the toggling of a filter, for example, selecting which status levels or types are to be displayed, at block 714, the items to be displayed are determined. Process flow then resumes at block 704, at which the new segmented graph showing the selected items is generated. As discussed herein, if the segmented graph is sufficiently small, all of the segments may be labeled. In another example, if the items selected are too numerous to be effectively displayed, e.g., the segments would be too small to differentiate, a new geometric shape, such as the stadium described with respect to FIG. 6 may be substituted.

If the user input is the activation of an entity, for example, by double clicking on a segment associated with the entity or the name of the entity, process flow proceeds to block 716. At block 716, the segmented graph display is replaced with a detail screen for the entity. The detail screen may include disks maps, block transfers, power supply voltages, or any number of other details. For example, the full context, such as the object, state, permissions, task flow, and the like, may be taken into account to determine the destination screen, its content and associated controls, and commands. When the user indicates a desire to exit the detail screen, for example, by clicking on an exit button, at block 718, the detail screen is removed, and process flow resumes at block 704.

The method 700 is not limited to the blocks shown in FIG. 7, but may include any number of other blocks or actions. For example, the user input may include the selection of a magnification tool for the display of further information about entities represented by segments under the tool. Further, from block 716, process flow can move to any number of other locations in addition to, or instead of, block 718, such as other detail screens, detail screens for other affected units, or segmented status graphs for other systems. The method 700 may also eliminate blocks shown.

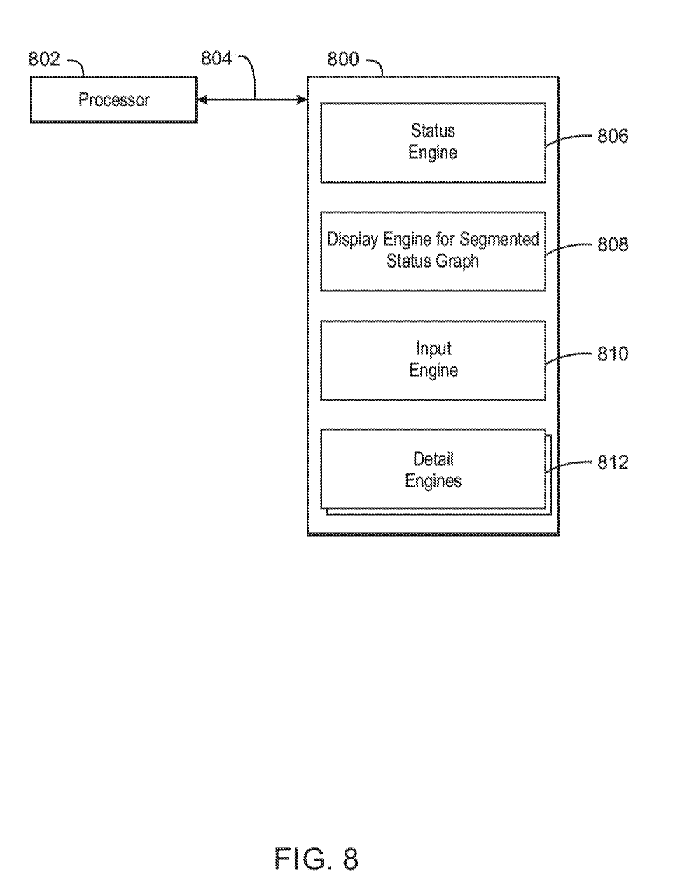

FIG. 8 is a block diagram of a computer readable medium 800 that includes modules for displaying a status of number of entities simultaneously. Each module includes code adapted to direct a processor 802 to perform actions for the display of the status of a number of entities in a segmented graph. The processor 802 accesses the modules over a system bus 804.

The modules can include a status engine 806 that determines the status of a number of entities. The status engine 806 may directly monitor the entities in the network or may access subsystems to poll for the status. In one example, a subsystem that monitors the status of an entity provides an interrupt to alert the status engine 806 of a status change for the entity.

Another module is a display engine 808. The display engine 808 takes the status information from the status engine 806, and generates a segmented status graph as described herein. The display engine 808 also refreshes, or redraws, the segmented graph after a user input has changed the entities to be displayed, the status levels, the selected entity, or other information.

The user input can be collected by an input engine 810. The input engine may also determine if the process flow should return to the display engine 810, or should proceed to a detail engine 812.

The detail engines 812 provide detailed screens about individual entities. The detail screens 812 may provide information that is specifically suited for the type of entity being monitored. For example, a detail screen for a disk may include remaining disk space, failed sectors, or transfer rates among others. A detail screen for a storage attached network may include information such as power supply voltages, power supply failures, network interface issues, disk drive allocation to virtual storage units, and the like.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method for displaying a status of entities in a segmented graph comprising:
representing a computing network as a geometric shape, wherein each of a plurality of segments of the geometric shape represent individual entities;
displaying a first region in the geometric shape to indicate the type of networked units represented by each of the plurality of segments;
displaying a second region that represents a first status level for an event for an entity; and
changing a color of a segment, or extending a length of the segment into the second region, or both, to indicate the first status level for the event.

2. The method of claim 1, comprising:
displaying a third region to indicate a second status level for an event; and
changing a color of the segment, or extending a length of the segment into the third region, or both, to indicate the second status level for the event.

3. The method of claim 1, comprising highlighting a segment by changing a color of the segment, changing a style of a border of the segment, extending a length of the segment, or any combinations thereof, when a screen pointer is positioned over the segment.

4. The method of claim 1, comprising displaying an identification of an entity associated with the segment when a screen pointer is positioned over the segment.

5. The method of claim 1, comprising displaying information about an entity when an associated segment is selected.

6. The method of claim 1, comprising accessing a detail information system for an entity when an associated segment is activated.

7. The method of claim 1, comprising displaying fewer or more segments in response to toggling a filter selection.

8. The method of claim 7, comprising displaying fewer or more segments in response to toggling an importance level.

9. The method of claim 7, comprising displaying fewer or more segments in response to toggling a type selection.

10. The method of claim 7, comprising displaying an identification label on each segment when the number of segments falls below a selected number.

11. The method of claim 1, comprising displaying a magnification tool to display an identification of every segment that falls underneath the magnification tool.

12. A system for accessing status for entities from a segmented graph, comprising a status system to be coupled to a plurality of network entities, wherein the status system comprises:
a processor; and
a storage system, wherein the storage system comprises code to direct the processor to:
represent each of the plurality of networked entities as a segment in a geometric shape on a display;
display a status for a networked entity by changing a color and a length of the entity;
display information for a networked entity when a screen cursor is positioned over an associated segment; and
access a detailed information screen for a networked entity when an associated segment is activated.

13. The system of claim 12, wherein a networked entity comprises a storage attached network, a drive, a power supply, a network system, or a computing system, or any combinations thereof.

14. The system of claim 12, wherein the geometric shape comprises an arc, a circle, a square, a stadium, or any combinations thereof.

15. A tangible, non-transitory, computer-readable medium, comprising instructions configured to direct a processor to:
obtain a status for a plurality of networked entities;
display a segmented graph wherein each segment represents a networked entity, and wherein a length, a color, or both of a segment represents the status of the networked entity; and
display further information on an entity in response to a selection of an associated segment.
